(19) United States
(12) Patent Application Publication
(10) Pub. No.: US 2019/0346648 A1
(43) Pub. Date: Nov. 14, 2019

(54) LOW FRICTION FLUTED LSZH INDOOR/OUTDOOR OPTIC FIBER CABLE

(71) Applicant: CommScope Technologies LLC, Hickory, NC (US)

(72) Inventors: Norin Paul Pausan, Rhyl (GB); David John Walker, Runcorn (GB); Amjed M S Abbas, Birkenhead (GB)

(73) Assignee: CommScope Technologies LLC

(21) Appl. No.: 16/522,444

(22) Filed: Jul. 25, 2019

Related U.S. Application Data
(63) Continuation of application No. PCT/US2018/016129, filed on Jan. 31, 2018.
(60) Provisional application No. 62/453,391, filed on Feb. 1, 2017.

(51) Int. Cl. G02B 6/44; G02B 6/54

(52) U.S. Cl. CPC G02B 6/4463; G02B 6/443; G02B 6/4434; G02B 6/54; G02B 6/4435

(57) ABSTRACT

A cable includes an inner core. In one embodiment, the inner core includes at least one optical fiber, plural flaccid strength members, such as aramid yarns, and at least one rigid strength member, such as one or more GRP rods. A jacket surrounds the inner core. The jacket has an undulating thickness which results in plural projections formed on an outer surface of the jacket, extending along the length of the cable. In a first embodiment, the at least one optical fiber is centrally located within the inner core and surrounded by a buffer tube, which is surrounded by plural GRP rods. In other embodiments, the at least one optical fiber is centrally located within the inner core and located within a channel formed in a single GRP rod or located within a buffer tube, which is placed in the channel formed in the single GRP rod.

This application is a continuation of International Application No. PCT/US2018/016129, filed Jan. 31, 2018, which claims the benefit of U.S. Provisional Application No. 62/453,391, filed Feb. 1, 2017, both of which are herein incorporated by reference.

### BACKGROUND OF THE INVENTION

### 1. Field of the Invention

The present invention is directed to a cable. More particularly, the present invention relates to a fiber optic cable with improved physical structures to enhance installation of the fiber optic cable into a conduit. The present invention also relates to a method of installing a cable into a conduit.

### 2. Description of the Related Art

Conduits or ducts are often employed in the cabling art as a convenient means to pass cables from a first location to a second location. A conduit is a tube, often formed of plastic, and may be constructed by linking several pieces of straight or curved conduit together using straight couplings or curved couplings, e.g., ninety degree couplings, forty five degree couplings.

One or more cables are passed through the conduit. The conduit provides protection for the cables from the elements and damage by people and/or animals in the area. The conduit can also provide a neat and orderly appearance to an area in which conduits are visible, as opposed to seeing a multitude of cables. The conduit can provide a hygienic environment wherein the conduit can be easily cleaned, whereas the multiple cables could not be easily or safely cleaned, as in the case of a commercial kitchen or an area of a hospital where patients are present.

Often times a cable needs to be added to an existing conduit, so as to add a new communication link between the first and second locations. The conduit may be empty or may be populated with one or more existing cables. Also, the conduit may be straight or may have one or more bends and couplings.

One known method of installing a cable, is to always leave a pull tape in the conduit. The existing pull tape extends from the first end of the conduit to the second end of the conduit and has first and second tails, which extend out of the first and second ends of the conduit, respectively. The pull tape is sometimes referred to as a pull rope, such as 200 lb. strength, polypropylene pull rope.

A technician attaches a new cable end to the first tail of the existing pull tape at the first end of the conduit, e.g., using an adhesive or clamping device. The technician then goes to the second end of the conduit and pulls the second tail of the existing pull tape. This process pulls the new cable through the conduit. Often times, a new tape is attached to the first tail of the existing tape, so that the new tape will replace the existing tape in the conduit, as the new cable is installed. The new tape will be ready if another cable needs to be installed at a later date.

This pulling method can be difficult for several reasons. The technician must overcome the frictional drag that exists when pulling the new cable and the new tape through the conduit. Many factors increase the frictional drag. The length of the conduit, the number of cables already existing in the conduit, the number of couplings in the conduit, the angles at which the conduit changes direction at each coupling, etc. Also, it sometimes occurs that an existing tape is absent in the conduit.

Sometimes, the second tail of the tape simply cannot be used to pull a new cable into the conduit. Even if more than enough force is available to pull the second tail of the existing tape, the tape will break, the coupling between the new cable and the first tail of the existing tape will separate, and/or the new cable will break.

There seems to be only two general methods of installing a new cable into an existing conduit. Those two general methods are pulling the new cable into the existing conduit, as by a tape as described above, or pushing the new cable into the existing conduit, as will now be described.

A cable may be pushed though an existing conduit if it has a certain level of rigidity, e.g., an electrical cable with solid core conductors, like the common twelve or fourteen gauge household power cables. The pushing operation may be accomplished by hand or by a machine that feeds the cable into the first end of the existing conduit.

A rather flaccid cable, which lacks the mechanical rigidity to be pushed for any extended length, may be pushed through an existing conduit using air pressure, e.g., blowing compressed air into the first end of the existing conduit to pass the cable from the first end to the second end of the existing conduit. Such a cable could also be pulled through the existing conduit by an air vacuum applied to the second end of the existing conduit to suck the new cable into the first end of the existing conduit and pull it to the second end of the existing conduit.

All of the above described methods have length limits. In other words, at some point, the frictional effects or drag of the new cable as it interacts with the interior wall of the conduit, the other existing cables within the conduit, the couplings, and the bends will eventually cause the new cable to stop moving. If the new cable stops moving before it reaches the second end of the existing conduit, the new cable must be withdrawn from the first end of the existing conduit and the insertion of the new cable must be attempted again, and often times again and again.

Several inventions in the prior have attempted to increase the length of new cable that can be inserted into an existing conduit. The inventions center on reducing the friction encountered by the new cable as it passes through the existing conduit.

It is known in the prior art to coat the new cable with a lubricant prior to inserting the new cable into the existing conduit. One such lubricant is sold under the trademark WHUPP! by the Assignee of the present application. Lubricants have a few disadvantages, such as an added cost, e.g., the Assignee recommends 1.5 gallons of WHUPP! be used to pull 1,000 of cable through a one inch conduit. All of the cables within the conduit must be compatible with the lubricant used, as some cable jackets deteriorate upon contact with certain lubricants. Lubricants, when exposed to dirt, construction dust, pollen, etc. accumulate these contaminants and cause the contaminants to adhere to the jacket of the lubricated cable. This is a particular problem when the initial installation attempt of a lubricated cable into an existing conduit fails and the cable must be withdrawn and piled onto the ground or a tarp before and a new attempt is made at installation. The withdrawn lubricated cable can get covered in contaminates and that makes the second and subsequent attempts at installation even more problematic.

Another attempt of the prior art to reduce the friction between the new cable and the interior wall of the existing conduit is to form the interior wall of the conduit with a material that is very slick and/or includes ribs. Conduits with interior walls enhanced by lubricating materials and/or ribbed interior walls are shown in U.S. Pat. Nos. 4,688,890; 4,892,442; 5,087,153; 5,238,328; and 5,678,609, which are herein incorporated by reference. FIGS. 1 and 2 show the ribbed interior wall of a conduit. See ribs 17 on the interior wall 21 of conduit 13 in FIG. 1, as taught in U.S. Pat. No. 4,688,890. Also, see ribs 20 on highly lubricous layer 12 of conduit 10 in FIG. 2, as taught in U.S. Pat. No. 4,892,442.

The ribs 17 and 20 cause less surface area to be contacted by the jacket of the new cable being installed. The reduced surface area contact translates into a lower frictional resistance. One drawback is that there are many conduits already in existence which do not have enhanced interior walls. There is a need to be able to reduce the friction between the cable jacket of a new cable when installing a new cable into an existing conduit, which does not have a ribbed interior wall or a highly lubricous layer applied to the interior wall. Also, the ribs 17 and 20 do nothing to reduce the friction encountered with existing cables within the conduits 13 and 10.

Another attempt at reducing the friction of a fiber optic cable that is blown into a conduit can be seen in U.S. Pat. No. 7,087,841, which is herein incorporated by reference. FIG. 3 is taken from U.S. Pat. No. 7,087,841 and depicts a jacket 1 having an inner space 2 designed to hold one or more optical fibers and optional conductors. The outer surface 3 of the jacket 1 includes a plurality of ribs 4.

According to U.S. Pat. No. 7,087,841, the ribs 4 enhance an ability to blow the cable into a conduit. See Col. 1, lines 47-61. Compressed air will flow through the channels between the ribs 4. If the jacket 1 is resting against the interior wall of the conduit, the channels nearest the interior wall will be smaller than the channels remote from the interior wall. Thus, the pressure in those channels will be greater and “a lifting effect” will occur to relieve friction between the interior wall of the conduit and the cable. See Col. 1, lines 55-61.

Additional background art can be found in U.S. Pat. Nos. 5,796,046; 5,990,419; 6,160,940; 6,912,347; 7,964,797; 7,974,507 and 8,565,564 and in US Published Applications 2004/0256139; 2005/0006132 and 2006/0032660, which are all herein incorporated by reference.

### SUMMARY OF THE INVENTION

The Applicant has appreciated some drawbacks in the background art, as noted above. With regard to U.S. Pat. No. 7,087,841, the Applicant notes that the cable is designed to be blown into a conduit. The ribs 4 are thin and designed to create lift. Many technicians do not desire to blow cables into a conduit. The blowing apparatus is rather expensive, heavy and bulky and must be transported to the job site, e.g., on a trailer.

Many technicians like to push a cable into a conduit using a mechanical device rather than a compressed air device. The mechanical device feeds the cable into the first end of the conduit mechanically and uses the rigidity of the cable itself to cause the cable to travel to the second end of the conduit. The feeding device is relatively smaller than the compressed air machine and can often times be powered by a common tool, like an electric or battery powered drill.

The Applicant believes that the cable show in U.S. Pat. No. 7,087,841 is not designed to be mechanically pushed into a conduit, as no mention is made of rigid strength members. Further, the ribs 4 of the cable appear to be insufficient to withstand a mechanical pushing method. The ribs 4 are very thin and would most likely be compressed flat against the channels between the ribs 4, if the cable were mechanically pushed into a conduit.

As such, it is an object of the present invention to address one or more of the drawbacks of the prior art, as noted above.

It is an object of the present invention to provide a cable, and method of installing a cable, which reduces the friction existing between the outer surface of the cable's jacket and the interior wall of the conduit, as the cable is installed into the conduit.

It is an object of the present invention to provide a cable having a reduced number of parts, which is cheaper to manufacture, which exhibits a lower level of friction when being pushed into a conduit, and/or which is easier to terminate to a connector.

It is an object of the present invention to provide a cable with a fluted outer shape for reducing the friction between the cable's jacket and the interior wall of the conduit. The cable can show a 50% reduction in friction with the conduit (all other things being equal). Consequently, the length of installed cable doubles without the need of using lubricants or air assisted installation, which make installation very simple.

It is an object of the present invention to provide a cable with a single rigid rod with a hollow channel proximate its central axis. At least one optical fiber resides within the channel. A jacket surrounds the single rigid rod. Flaccid strength members, like yarns, may optionally reside between the single rigid rod and the jacket. Such a design provides a fiber optic cable with an extremely small outer diameter, which still exhibits a good ability to be pushed into a small diameter conduit, and which has a centrally disposed optical fiber to be easily terminated to a connector.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a cross sectional view of a first conduit with a ribbed interior wall, in accordance with the background art;

FIG. 2 is a perspective view of a second conduit with a ribbed interior wall, in accordance with the background art;

FIG. 3 is a cross sectional view of a fiber optic cable with thin ribs on an outer surface of a jacket, in accordance with the background art;

FIG. 4 is a perspective view of an end of a length of cable, in accordance with a first embodiment of the present invention;

FIG. 5 is a perspective view of an end of a length of cable, in accordance with a second embodiment of the present invention;

FIG. 6 is a cross sectional view taken along line VI-VI in FIG. 5;

FIG. 7 is close up view of an outer surface of a jacket showing a variation of the second embodiment, wherein projections are slightly spaced apart;

FIG. 8 is a perspective view of an end of a length of cable, in accordance with a third embodiment of the present invention;

FIG. 9 is a cross sectional view taken along line IX-IX in FIG. 8;

FIG. 10 is close up view of an outer surface of a jacket of the third embodiment showing how a ratio of height to average width of a projection may be calculated;

FIG. 11 is a cross sectional view of a cable, in accordance with a fourth embodiment of the present invention;

FIG. 12 is close up view of an outer surface of a jacket of the fourth embodiment showing how a ratio of height to average width of a projection may be calculated;

FIG. 13 is a perspective view of an end of a length of cable, in accordance with a fifth embodiment of the present invention; and

FIG. 14 is a cross sectional view taken along line XIV-XIV in FIG. 13.

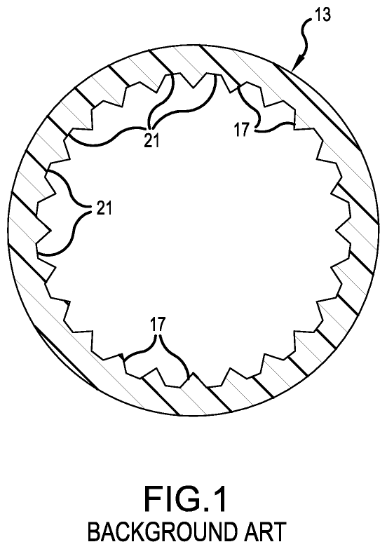

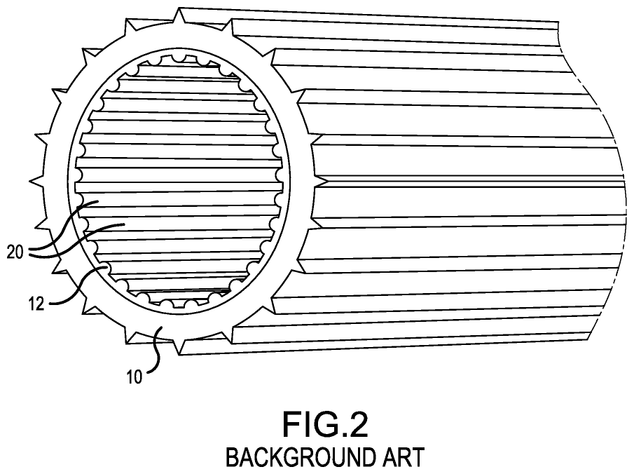

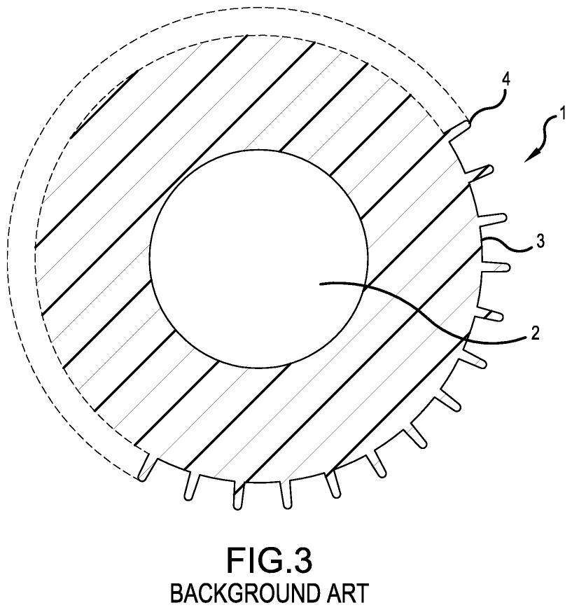

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

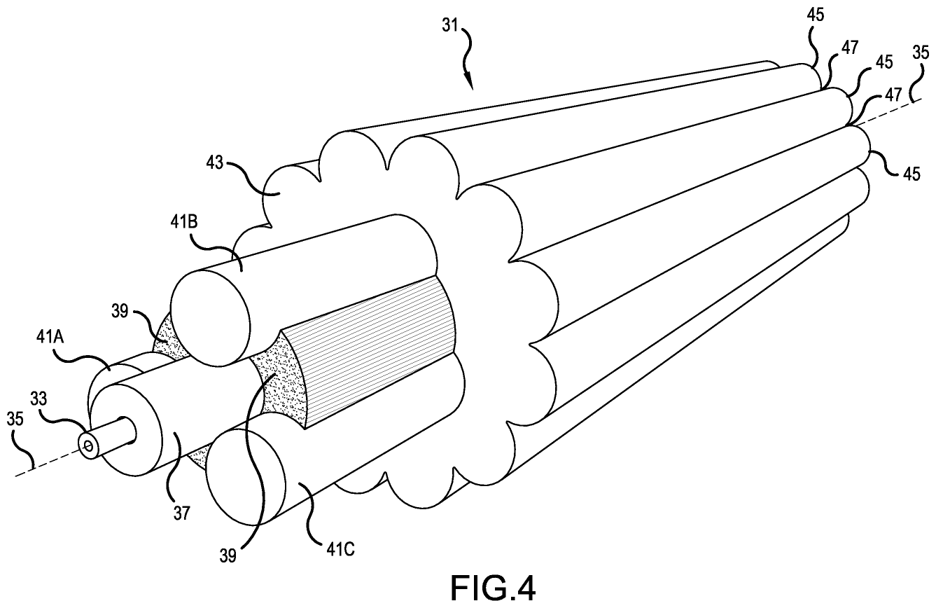

FIG. 4 is a perspective view of an end of a length of cable 31, in accordance with a first embodiment of the present invention. FIG. 4 shows a short length of cable 31. Of course, the cable 31 would typically be sold in extended lengths, e.g., 1,000 feet coiled into a box or wound on a spool.

The cable 31 includes an inner core with a member for transmitting data signals. As shown in FIG. 4, the member is a single optical fiber 33, such as a 250 micron diameter optical fiber. The optical fiber 33 is centrally located along a center axis 35 of the cable 31.

A buffer tube 37 surrounds the optical fiber 33. The buffer tube 37 is also centered along the axis 35 of the cable 31. Although FIG. 4 depicts a single optical fiber 33 within the buffer tube 37, it should be appreciated that more than one optical fiber 33 may be located within the buffer tube 37, such as two, four, eight, or even up to twenty-four optical fibers. Also, FIG. 4 shows a loose optical fiber 33 within the opening of the buffer tube 37. Instead of a “loose-tube” arrangement, the invention may include a “tight-tube” arrangement.

The inner core of the cable 31 also includes a plurality of flaccid strength members. In one embodiment, the flaccid strength members are fibers or yarns 39 completely surrounding the buffer tube 37. The yarns 39 may be constructed of aramid yarns, such as those sold under the trademark of KEVLAR. The yarns 39 are important to allow for attachment of a connector at the termination ends of the cable 31, as the yarns 39 may be clamped or adhered to the connector to provide strain relief, so that the optical fiber 33 is not strained by the connector at the termination end of the cable 31.

At least one rigid strength member 41 is provided within the inner core. In the embodiment of FIG. 4, three glass reinforced plastic (GRP) rods 41A, 41B and 41C are spaced evenly, e.g., at equal intervals of one hundred twenty degrees apart, around the buffer tube 37. The rigid strength members 41 are disposed within the yarns 39. Although GRP rods have been described, other types of rigid rods may be substituted. Also, the three rigid strength members 41A, 41B and 41C may be replaced by two rigid strength members 41A and 41B spaced one hundred and eighty degrees apart, e.g., on opposite sides of the buffer tube 37.

A jacket 43 surrounds the inner core. More specifically, the jacket 43 surrounds the optical fiber 33, the buffer tube 37, the yarns 39 and the rigid strength members 41A, 41B and 41C. The jacket 43 has an undulating thickness entirely around the inner core to form a plurality of alternating projections 45 and valleys 47 on the outer surface of the jacket 43. The projections 45 and valleys 47 extend along the length of the cable 31.

The plural projections 45 include at least five projections 45 with a valley 47 formed between each adjacent pair of projections 45. In the embodiment shown in FIG. 4, there are twelve projections 45. However, more or fewer projections 45 may be included, such as six, eight, nine, ten, fourteen, fifteen, etc.

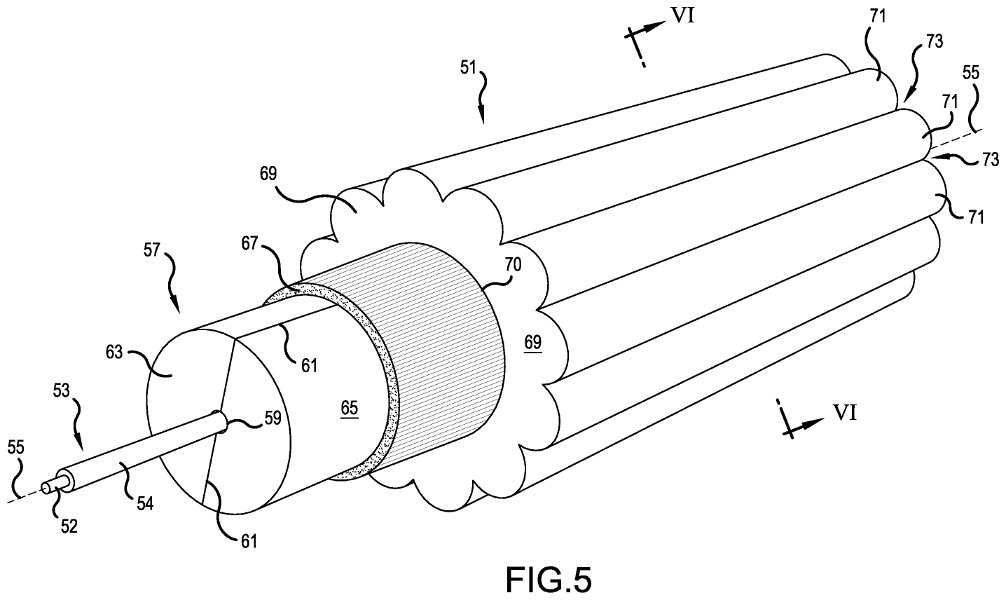

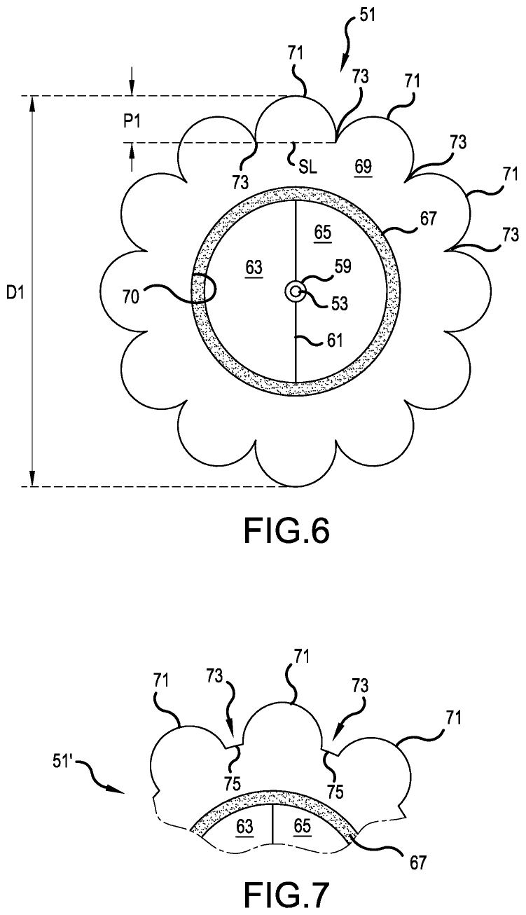

FIG. 5 is a perspective view of an end of a length of cable 51, in accordance with a second embodiment of the present invention. FIG. 6 is a cross sectional view taken along line VI-VI in FIG. 5. The cable 51 has an inner core with a member for transmitting data signals. As shown in FIGS. 5 and 6, the member is a single optical fiber 53, such as a 250 micron diameter optical fiber. The optical fiber 53 is centrally located along a center axis 55 of the cable 51, and may include a cladding layer 54 surrounding a light carrying core 52.

The second embodiment does not include a buffer tube. Rather, a single rigid strength member 57 is provided in the inner core. The rigid strength member 57 has a hollow channel 59 proximate its central axis, and the optical fiber 53 resides within the channel 59. In one embodiment, the channel 59 has a diameter of about 500 microns, so that a single optical fiber 53 has a loose fit. Of course, the diameter of the channel 59 may be made larger and more than one optical fiber 53 may reside within the channel 59, e.g., two optical fibers, four optical fibers, up to twenty four optical fibers may reside within a larger channel 59.

The rigid strength member 57 is formed as a rigid cylindrical rod with a circular cross sectional shape. A central axis of the rigid strength member 57 resides along the center axis 55 of the cable 51. A break line 61 passes through the channel 59 and divides the rigid strength member 57 into first and second mirror symmetrical halves 63 and 65. The first half 63 of the rigid strength member 57 is attached to the second half 65 of the rigid strength member 57 after the optical fiber 53 is placed into the channel 59.

The inner core of the cable 51 also includes a plurality of flaccid strength members. In one embodiment, the flaccid strength members are fibers or yarns 67 completely surrounding the rigid strength member 57, and form a layer approximately 0.3 mm thick. As noted above, the yarns 67 may be constructed of aramid yarns, such as those sold under the trademark of KEVLAR.

A jacket 69 surrounds the inner core. More specifically, the jacket 69 surrounds the optical fiber 53, the rigid strength member 57, and the yarns 67. As shown in FIGS. 5 and 6, the jacket 69 presents an inner wall 70 with a circular cross sectional shape, which faces to the inner core. The jacket 69 has an undulating thickness entirely around the inner core to form a plurality of alternating projections 71 and valleys 73 on the outer surface of the jacket 69. The projections 71 and valleys 73 extend along the length of the cable 51.

The plural projections 71 include at least five projections 71 with a valley 73 formed between each adjacent pair of projections 71. In the embodiment shown in FIGS. 5 and 6, there are twelve projections 71. However, more or fewer projections 71 may be included, such as six, eight, nine, ten, fourteen, fifteen, etc. The overall diameter D1 of the cable 51 is approximately 5 mm, such as less than 5.5 mm. The projection height P1 for each projection is approximately 0.5 mm.

In the embodiment shown in FIGS. 5 and 6, the projections 71 touch each other to form a valley 73 with a deep V-shape. However, as illustrated in the close-up portion of a modified cable 51′ in FIG. 7, the projections 71 may be slightly spaced from each other so that short segment of a curved floor 75 is formed between the projections 71.

In a preferred embodiment, the first and second halves 63 and 65 of the rigid strength member 57 are each formed of glass reinforced plastic (GRP) and are attached together, e.g., by heating or an outer coating, after the optical fiber 53 is inserted into the channel 59. Alternatively, the first and second halves 63 and 65 may be held together by the outer jacket 69, which is extruded over the interior core. In a preferred embodiment, the rigid strength member 57 does not slide within the jacket 69, and may be bonded to the jacket 69, and the rigid strength member 57 has a diameter of about 2.4 mm.

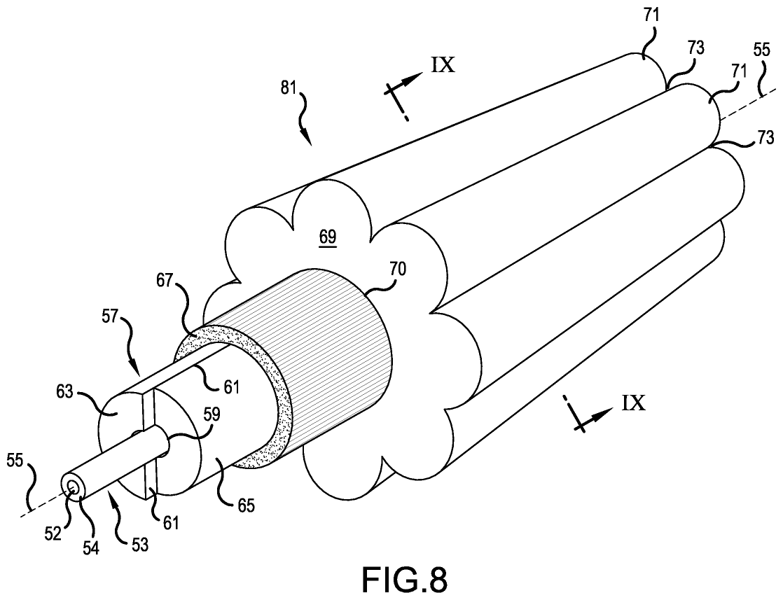

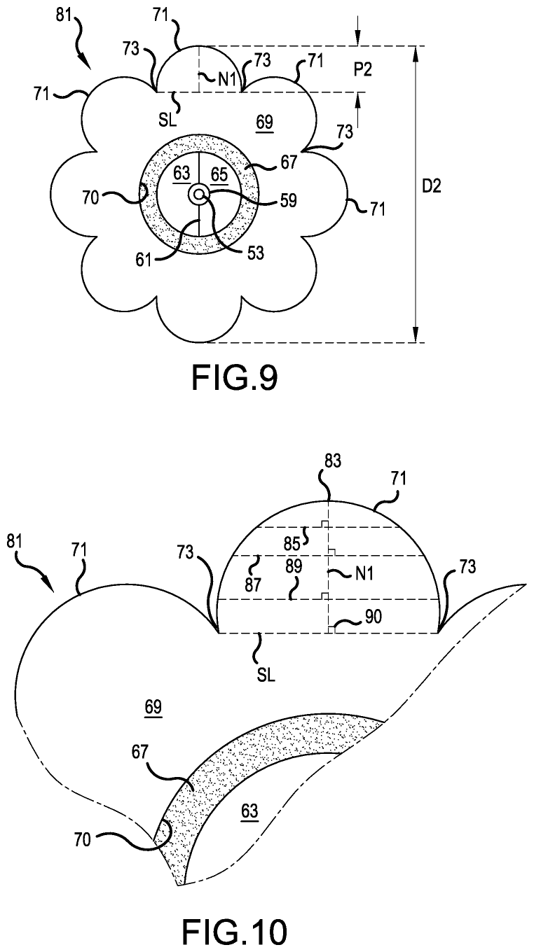

FIG. 8 is a perspective view of an end of a length of cable 81, in accordance with a third embodiment of the present invention. FIG. 9 is a cross sectional view taken along line IX-IX in FIG. 8. The cable 81 is constructed almost identically to the cable 51 of FIGS. 5 and 6. Therefore, like structures have been identified using the same reference numerals as used in FIGS. 5 and 6. The cable 81 is generally smaller than the cable 51. Some notable corresponding differences are that the number of projections 71 is illustrated to be eight, and the number of valleys 73 is likewise eight. The overall diameter D2 of the cable 81 is approximately 3.5 mm. The projection height P2 for each projection is approximately 0.48 mm. The diameter of the rigid strength member 57 is about 1 mm, and the thickness of the layer of yarns 67 is about 0.4 mm.

All of the preferred dimensions given for the second and third embodiments should be considered optimum values for the particular arrangements depicted, and the actual values may vary, e.g., by plus or minus 5%. In FIG. 8, the first half 63 of the rigid strength member 57 has an extended length creating a lip to better illustrate the break 61 between the first and second halves 63 and 65 of the rigid strength member 57.

Now, with reference to the close up view of FIG. 10, the height of each projection 71 for the embodiments of the present invention is measured along a first normal line N1 extending away at ninety degrees 90 from a straight line SL connecting the lowest points in the valleys 73, located to the sides of the projection 71, to a peak 83 of the projection 71. The lowest points in the valleys 73 are the closest points on the outer surface of the jacket 69 to the center axis 55 of the cable 51, 81. The peak 83 of the projection 71 is the most remote point on the outer surface of the jacket 69 from the center axis 55 of the cable 51, 81.

An average width of each projection 71 is the average of all widths of the projection 71, as measured from the peak 83 to the straight line SL connecting the lowest points in the valleys 73, located to the sides of the projection 71. All widths are measured between the outer surfaces of the jacket forming the projection 71, along second normal lines extending away at ninety degrees from the first normal line N1. For example, FIG. 10 illustrates three of the widths used in the calculation to average all of the widths of the projection 71. In FIG. 10, a first line 85 shows a second normal line proximate the peak 83 of the projection 71. A second line 87 shows another second normal line proximate the middle of the projection 71. A third line 89 shows another second normal line proximate the base of the projection 71, i.e., near the straight line SL. The average width is the average of the lengths of all of the second normal lines and can be readily determined using geometry when the shape of the projection is known, as will be explained further below.

In accordance with an embodiment of the present invention, for each projection 71, a ratio of the height, e.g., the length of line N1, to the average width is less than 1.5. More preferable, the ratio is less than 1.25. In some embodiments, the ratio may even be less then 1.0. The ratio represents a quantifiable way to measure the stability of the projection 71. The highly stable projections 71 will not deform or fold over when they encounter the interior wall of the conduit or other existing cables within the conduit.

FIGS. 4-10 have illustrated a cross sectional shape of each projection 71 presenting about half of an ellipse. In the previous embodiments, the ellipse is nearly circular, and each projection 71 represents slightly more than half of the ellipse. Of course, the shape may be varied while still maintaining the preferred ratio of height to average width.

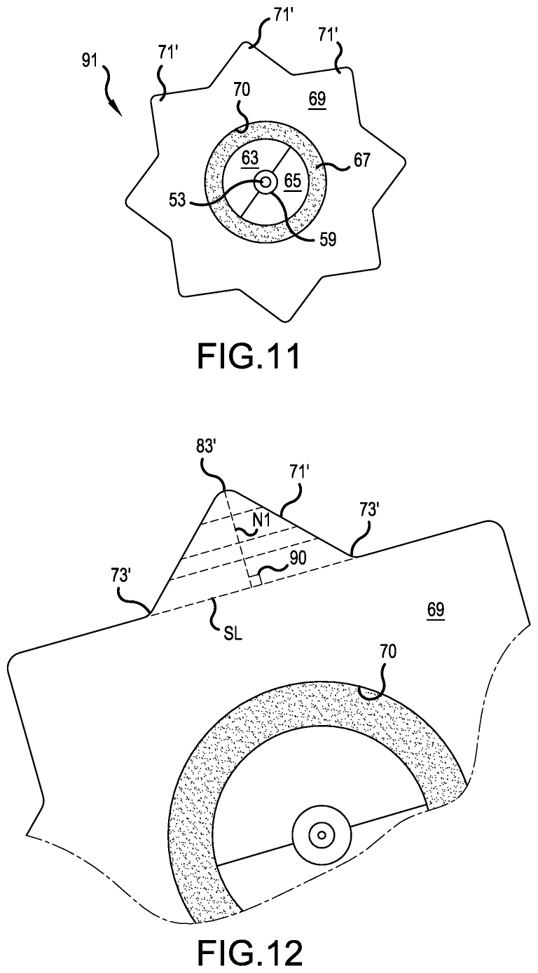

For example, FIG. 11 is a cross sectional view of cable 91, in accordance with a fourth embodiment of the present invention. The cable 91 is the same as the cable 81 of FIGS. 9 and 10, except that the projections 71′ have a triangular cross sectional shape.

Now with reference to the close up view of FIG. 12, the height of each projection 71′ for the fourth embodiment of the present invention is measured along the first normal line N1 extending away at ninety degrees 90 from the straight line SL connecting the lowest points in the valleys 73′, located to the sides of the projection 71′, to the peak 83′ of the projection 71′. As the projection 71′ is approximately a triangle, the average width can be calculated using geometry and will be ½ the length of the straight line SL.

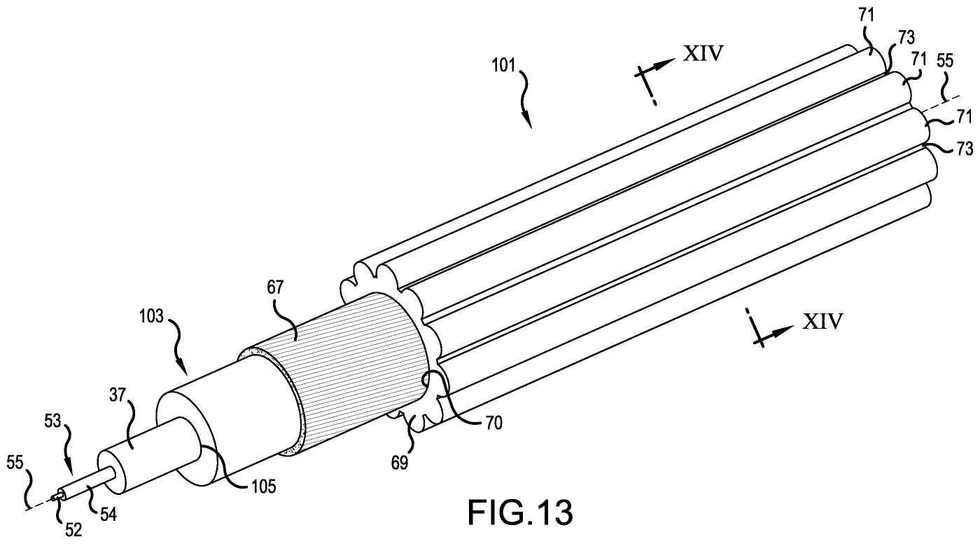

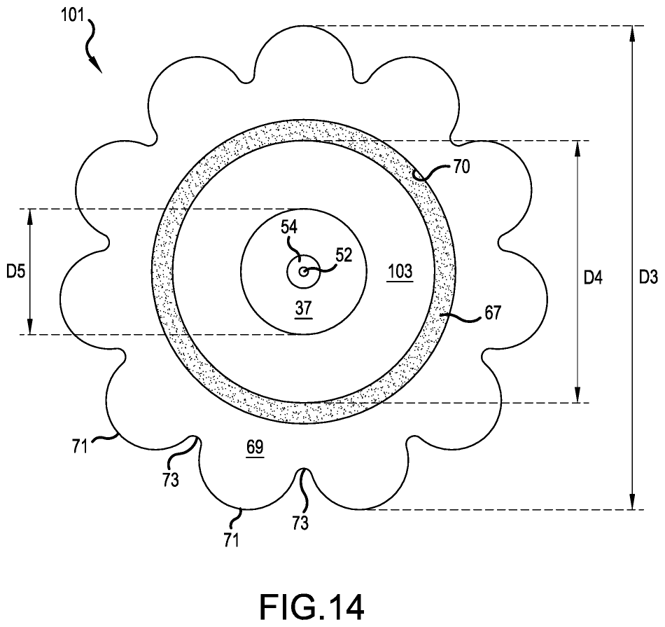

FIG. 13 is a perspective view of an end of a length of cable 101, in accordance with a fifth embodiment of the present invention. FIG. 14 is a cross sectional view taken along line XIV-XIV in FIG. 13. The cable 101 is constructed similarly to the cable 51 of FIGS. 5 and 6. Therefore, like structures have been identified using the same reference numerals as used in FIGS. 5 and 6.

The cable 101 has an inner core with a member for transmitting data signals. As shown in FIGS. 13 and 14, the member is a single optical fiber 53, such as a 250 micron diameter optical fiber. The optical fiber 53 is centrally located along a center axis 55 of the cable 101, and may include a cladding layer 54 surrounding a light carrying core 52.

The fifth embodiment includes a buffer tube 37. The buffer tube 37 may have a diameter D5 of less than about 1.4 mm, such as less than about 1.2 mm, such as about 0.9 mm. The single optical fiber 53 is “tightly fitted” into a central opening of a buffer tube 37, but may optionally be “loosely fitted,” as shown in FIG. 4. Further, more than one optical fiber 53 may reside loosely or tightly within the central opening of the buffer tube 37, e.g., two optical fibers, four optical fibers, up to twenty four optical fibers may reside within the buffer tube 37.

A single rigid strength member 103 is provided in the inner core. The rigid strength member 103 has a hollow channel 105 proximate its central axis, and the buffer tube 37 resides within the channel 105. In the illustrated embodiment, the channel 105 has a diameter D5 of about 0.9 mm, so that the buffer tube 37 has a tight fit. Of course, the diameter of the channel 105 may be made slightly larger than the diameter of the buffer tube 37.

The rigid strength member 103 is formed as a rigid cylindrical rod with a circular cross sectional shape, having a diameter D4. In a preferred embodiment, the diameter D4 is less than 2.5 mm, such as less than about 2.0 mm, such as about 1.9 mm. A central axis of the rigid strength member 103 resides along the center axis 55 of the cable 101. The inner core of the cable 101 also includes a plurality of flaccid strength members. In one embodiment, the flaccid strength members are fibers or yarns 67 completely surrounding the rigid strength member 103, and form a layer less than 0.5 mm thick, such as less than 0.4 mm thick, such as approximately 0.3 mm thick. As noted above, the yarns 67 may be constructed of aramid yarns, such as those sold under the trademark of KEVLAR, and may also include a water blocking ability.

A jacket 69 surrounds the inner core. More specifically, the jacket 69 surrounds the optical fiber 53, the rigid strength member 103, and the yarns 67. As shown in FIGS. 13 and 14, the jacket 69 presents an inner wall 70 with a circular cross sectional shape, which faces to the inner core. The jacket 69 has an undulating thickness entirely around the inner core to form a plurality of alternating projections 71 and valleys 73 on the outer surface of the jacket 69. The projections 71 and valleys 73 extend along the length of the cable 101.

The plural projections 71 include at least five projections 71 with a valley 73 formed between each adjacent pair of projections 71. In the embodiment shown in FIGS. 13 and 14, there are eleven projections 71. However, more or fewer projections 71 may be included, such as six, eight, nine, ten, fourteen, fifteen, etc. The overall diameter D3 of the cable 101 is approximately 3.5 mm, like the embodiment of FIGS. 8 and 9. In the embodiment shown in FIGS. 13 and 14, the projections 71 touch each other to form a valley 73 with a curved U-shape.

In all of the embodiments, the rigid strength members 41, 57, 103 impart rigidity to the overall cable 31, 51, 51′, 81, 91, 101, which allows the cable 31, 51, 51′, 81, 91, 101 to be pushed into the conduit by hand or by a machine. Preferably, the rigid strength members 41, 57, 103 cause the cable 31, 51, 51′, 81, 91, 101 to tend to follow a straight line, e.g., the natural resiliency of the rigid strength member 41, 57, 103 causes it to tend to return to a straight line. The natural resiliency can have a strength measurement. For example, if a three foot length of cable 31 were supported by a clamp holding one end of the cable horizontal, the opposite end of the cable 31 would not sag down more than 18 inches from the horizon. More preferably, the opposite end of the cable would not sag by more than 12 inches, such as less than 10 inches or less than 8 inches.

The cables 31, 51, 51′, 81, 91, 101 as described above, may be installed into a conduit having a first end and a second end. The conduit may have a very small inner diameter, such as 8 mm or less, such as 7 mm or less, such as approximately 6 mm. Such conduits are so small that digging dirt is not needed to install the conduit in the ground. Rather, a slice is made into the ground using a knife-like attachment on a tractor. The conduit is inserted into the cut in the ground, and the ground is pressed back together by a roller or walking on the cut section of ground. These small conduits are especially advantageous when running a conduit from a curb to a subscriber's house through a yard, as minimal to no damage is made to the yard.

After the conduit is in the ground, a first step would be inserting a first end of the cable into a feeding tool attached to the first end of the conduit. Powering the feeding tool, such as by engaging the feeding tool with a power drill. Consequently, pushing the cable into the first end of the conduit (proximate the curb) until the first end of the cable exits the second end of the conduit (proximate the subscriber's house). The small diameter of the cables 31, 51, 51′, 81, 91, 101 of the present invention, particularly the diameter D3 of cable 101, in combination with the rigid strength members 41, 57, 103 make the cables of the present invention idea for pushing through the small diameter conduits for distances up to 40 meters, such as up to 30 meters, such as up to 20 meters.

The cables 31, 51, 51′, 81, 91, 101 of the present invention have several features which may prove beneficial in terminating the cable end to a connector. For example, the aramid yarns 39, 67 are important to allow for attachment of a connector, as the yarns 39, 67 can be clamped or adhered to the connector body to provide strain relief to the optical fiber 33, 53. Also, the centrally located optical fiber or fibers, improves the connector attachment, allowing the communication port of the connector to be centered on the connector body and avoiding the need to reroute the optical fibers 33, 53 to the center of the connector body. Further, the circular inner wall 70 of the jacket 69 in FIGS. 5-12 could accommodate a circular collar of the connector body to be inserted therein and to assist in stabilizing the connector attachment to the end of the cable 51, 51′, 81, 91, 101.

All of the above jackets 43 and 69 may be formed of a low smoke, zero halogen (LSZH) material, a polyethylene material (which is particularly well suited for outdoor uses), or other compounds, as best suited to the deployment environment. Although the description above has detailed embodiments of cables with projections numbering eight, eleven and twelve, it is within the purview of the prevent invention to produce cables with more or fewer projections, such as six, nine, ten, fourteen, fifteen, etc.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A cable comprising:
a single rigid rod with a hollow channel proximate its central axis;
at least one optical fiber residing within said channel; and
a jacket surrounding said single rigid rod.

2. The cable according to claim 1, wherein said single rigid rod is a glass reinforced plastic (GRP) rod.

3. The cable according to claim 2, further comprising:
plural flaccid strength members surrounding said single rigid rod, wherein said jacket surrounds said plural flaccid strength members.

4. The cable according to claim 3, wherein said plural flaccid strength members include a plurality of aramid yarns.

5. The cable according to claim 2, wherein said at least one optical fiber is a single optical fiber, such that only a single optical fiber resides within said channel.

6. The cable according to claim 5, wherein said single rigid rod has a circular cross sectional shape with a break line passing through said channel and forming first and second halves, and wherein said first half of said single rigid rod is attached to said second half of said single rigid rod after said single optical fiber is placed into said channel.

7. The cable according to claim 2, wherein said jacket has an undulating thickness which results in plural projections formed on an outer surface of said jacket, which projections extend along the length of the cable.

8. The cable according to claim 7, wherein said plural projections include at least five projections with a valley formed between each adjacent pair of projections.

9. The cable according to claim 8,
wherein a height of each projection is measured along a first normal line extending away at ninety degrees from a straight line connecting the lowest points in said valleys, located to the sides of said projection, to a peak of said projection, wherein the lowest points in said valleys are the closest points on the outer surface of said jacket to a center axis of said cable, and the peak of said projection is the most remote point on the outer surface of said jacket from said center axis of said cable;
wherein an average width of each projection is the average of all widths of said projection as measured from said peak to said straight line connecting said lowest points in said valleys, located to the sides of said projection, wherein all widths are measured between the outer surfaces of the jacket forming said projection, along second normal lines extending away at ninety degrees from said first normal line; and
wherein for each projection, a ratio of said height to said average width is less than 1.5.

10. The cable according to claim 8, wherein in cross section, each said projection presents about half of an ellipse.

11. The cable according to claim 8, wherein in cross section, each said projection presents an approximate triangle.

12. The cable according to claim 2, further comprising:
a buffer tube surrounding said at least one optical fiber and residing within said channel.

13. The cable according to claim 12, wherein said jacket has an undulating thickness which results in plural projections formed on an outer surface of said jacket, which projections extend along the length of the cable.

14. A cable comprising:
a single rigid rod with a hollow channel proximate its central axis;
at least one member for transmitting data signals residing within said channel; and
a jacket surrounding said single rigid rod.

15. The cable according to claim 14, wherein said jacket has an undulating thickness which results in plural projections formed on an outer surface of said jacket, which projections extend along the length of the cable.

16. The cable according to claim 15, wherein said plural projections include at least five projections with a valley formed between each adjacent pair of projections.

17. The cable according to claim 16, wherein a height of each protection is measured along a first normal line extending away at ninety degrees from a straight line connecting the lowest points in said valleys, located to the sides of said projection, to a peak of said projection, wherein the lowest points in said valleys are the closest points on the outer surface of said jacket to a center axis of said cable, and the peak of said projection is the most remote point on the outer surface of said jacket from said center axis of said cable;
wherein an average width of each projection is the average of all widths of said projection as measured from said peak to said straight line connecting said lowest points in said valleys, located to the sides of said projection, wherein all widths are measured between the outer surfaces of the jacket forming said projection, along second normal lines extending away at ninety degrees from said first normal line; and
wherein for each projection, a ratio of said height to said average width is less than 1.5.

18. The cable according to claim 17, wherein in cross section, each said projection presents about half of an ellipse or an approximate triangle.

19. A cable comprising:
at least one rigid strength member;
at least one optical fiber;
a jacket surrounding said at least one rigid strength member and said at least one optical fiber, wherein said jacket has an undulating thickness which results in plural projections formed on an outer surface of said jacket, which projections extend along the length of the cable;
a buffer tube surrounding said at least one optical fiber; and
a plurality of yarns surrounding said buffer tube, wherein said at least one rigid strength member is three glass reinforced plastic (GRP) rods spaced evenly around said buffer tube, and wherein said jacket surrounds said buffer tube, said plurality of yarns and said three GRP rods.

20. The cable according to claim 19, wherein in cross section, each said projection presents about half of an ellipse.
